(19) United States
(12) Patent Application Publication
(10) Pub. No.: US 2025/0150967 A1
(43) Pub. Date: May 8, 2025

(54) DEVICE, SYSTEM, AND METHOD FOR RESTRICTED TARGET WAKE TIME COORDINATION BETWEEN ACCESS POINTS

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/923,529

(22) Filed: Oct. 22, 2024

Related U.S. Application Data
(60) Provisional application No. 63/596,176, filed on Nov. 3, 2023.
(60) Provisional application No. 63/550,267, filed on Feb. 6, 2024.

(51) Int. Cl. H04W 52/02

(52) U.S. Cl. CPC H04W 52/0216

(57) ABSTRACT

A method and system for restricted target wake time (r-TWT) coordination where a first AP in a basic service set (BSS) respects an r-TWT schedule of a second AP, where the second AP is in an overlapping basic service set (OBSS). The first AP acquires the r-TWT schedule of the second AP and indicates to the second AP that the first AP respects the r-TWT schedule of the second AP. The first AP provides to a station associated with the first AP an indication of the r-TWT schedule of the second AP to cause a frame exchange with the STA of the first AP to end at a beginning of a r-TWT service period of the second AP to respect the r-TWT schedule of the second AP.

### CROSS-REFERENCE TO RELATED APPLICATIONS

This application is entitled to the benefit of U.S. Provisional Patent Application Ser. No. 63/596,176, filed Nov. 3, 2023, entitled “r-TWT Coordination” and U.S. Provisional Patent Application Ser. No. 63/550,267, filed Feb. 6, 2024, entitled “r-TWT Coordination Simplification”, the contents each of which are incorporated by reference herein in its entirety.

### FIELD OF USE

This disclosure generally relates to wireless communication, and more particularly to restricted target wake time (r-TWT) coordination between access points (APs).

### BACKGROUND

A wireless network includes a plurality of access points (APs) which transmit and receive frames with a respective plurality of client stations (STA) over a communication link. Target Wake Time (TWT) which is a feature of the Institute of Electrical and Electronics Engineers (IEEE) 802.11 standard defines a wake time of an access point (AP) to facilitate scheduling transmission of frames and improve power efficiency. Some applications (e.g., cloud gaming, AR glasses) have periodic burst traffic with very strict latency requirements. A restricted target wake time (r-TWT) schedule better supports latency sensitive applications. The AP defines r-TWT service periods (SP) in an r-TWT schedule to transmit or receive latent sensitive frames. The AP and STAs associated with the AP have a guaranteed transmit opportunity (TXOP) which helps flow of the latency-sensitive frames.

### BRIEF DESCRIPTION OF THE DRAWINGS

FIG. 1 depicts an example wireless system for restricted target wake time (r-TWT) coordination between APs in a basic service set (BSS) and overlapping BSS (OBSS) in accordance with one or more embodiments.

FIG. 2 illustrates various examples associated with r-TWT coordination between an AP in a BSS and AP in the OBSS in accordance with one or more embodiments.

FIG. 3 illustrates example formats of fields in a beacon to indicate an r-TWT schedule in accordance with one or more embodiments.

FIG. 4 illustrate example communication by an AP to respect an r-TWT schedule of the AP in the OBSS where the r-TWT schedule is not announced to associated stations in accordance with one or more embodiments.

FIG. 5 is an example flow chart of functions associated with r-TWT coordination between the AP in the BSS and AP in the OBSS in accordance with one or more embodiments.

Throughout the description, similar reference numbers may be used to identify similar elements.

### DETAILED DESCRIPTION

The detailed description of the appended drawings is intended as a description of the currently preferred embodiments of the present disclosure, and is not intended to represent the only form in which the present disclosure may be practiced. It is to be understood that the same or equivalent functions may be accomplished by different embodiments that are intended to be encompassed within the spirit and scope of the present disclosure.

An AP and associated respective STAs define a basic service set (BSS) where the AP is a virtual AP of a co-hosted AP set located in a physical AP device, an AP in a AP multi-link device (MLD), an AP in a co-hosted AP set located in a physical AP device, or a virtual AP of a plurality of virtual APs set located in a physical AP device and which belongs to a multiple BSSID set. Two neighbor APs negotiate a r-TWT schedule agreement and the agreed r-TWT schedule of one AP is respected by another AP if the agreement is reached. One AP or a STA associated with the AP as the TXOP holder of a transmit opportunity (TXOP) needs to end its TXOP at a beginning of a negotiated r-TWT SP of another AP to respect the r-TWT SP of the other AP if the two APs negotiated the coordinated R-TWT schedule agreement for the r-TWT SP (or the r-TWT schedule agreement covering the r-TWT SP).

Embodiments disclosed herein are directed to restricted target wake time (r-TWT) coordination between an AP in a basic service set (BSS) and an AP in an overlapping basic service set (OBSS) so that the r-TWTs of the APs are respected. The APs are in different BSS and the AP in the OBSS coordinates r-TWT operation with the AP in an BSS by transmitting its r-TWT schedule in a beacon, public action frame(s) as part of a r-TWT schedule agreement negotiation, or the AP of the BSS transmitting and receiving request to send/clear to send (RTS/CTS), multi-user RTS (MU-RTS)/CTS, or other frame exchange with an associated station so that the AP in the BSS respects the r-TWT schedule of the AP in the OBSS. A station associated with the AP in the BSS is further provided with an indication of a clock drift between a timing synchronization function (TSF) time of the AP in the BSS and TSF time of the AP in the OBSS and a time unit (TU) start time difference (or TSF start time difference) of the r-TWT service period (SP) of the AP in the OBSS based on a respective TSF time of the AP in the BSS and AP in the OBSS which are used by the STA to determine an actual start time of a r-TWT SP of the AP in the OBSS. In one or more embodiments, the STA will end frame transmissions in a transmit opportunity (TXOP) before the start time of the r-TWT SP of the AP in the OBSS to respect the r-TWT SP of the AP in the OBSS by considering the TU start time difference and clock drift of the two AP's TSF time. Well known instructions, protocols, structures, and techniques have not been shown in detail in order not to obfuscate the description.

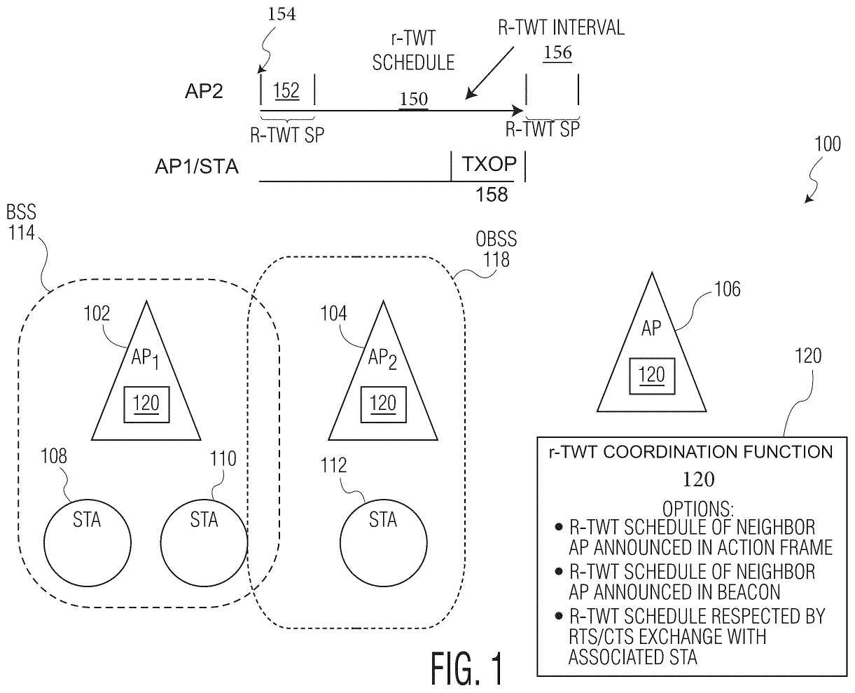

FIG. 1 depicts an example wireless system 100 for restricted target wake time (r-TWT) coordination between APs in a BSS and OBSS in accordance with one or more embodiments. The wireless system 100 includes one or more wireless devices such as one or more access points (APs) 102-106 and one or more client stations (STA or non-AP STAs) 108-112 which are non-AP STAs that operate based on the Institute of Electrical and Electronics Engineers (IEEE) 802.11 standard compatible with an IEEE 802.11bn protocol and various other iterations of the 802.11 specification are referred to herein including but not limited to IEEE 802.11ac, IEEE 802.11be, and IEEE 802.11ax. IEEE 802.11ac is referred to as very high throughput (VHT). IEEE 802.11ax is referred to as high efficiency (HE). IEEE 802.11be is referred to as extreme high throughput (EHT). IEEE 802.11bn is referred to as ultra-high reliability (UHR). In one or more embodiments, the wireless devices each include at least one antenna, at least one transceiver operably connected to the at least one antenna, and at least one controller operably connected to the corresponding transceiver. In some embodiments, at least one transceiver is a physical layer (PHY) device. The at least one controller may be configured to control the at least one transceiver to process packets. In some embodiments, the at least one controller may be implemented within a processor, such as a microcontroller, a host processor, a host, a digital signal processor (DSP), or a central processing unit (CPU). The wireless system 100 may have fewer or more APs or STAs than as illustrated. An AP 102-106 as described herein may each be an affiliated AP in an AP multi-link device (MLD), a virtual AP of a co-hosted AP set located in a physical AP device, an AP of a co-hosted AP set located in a physical AP device, or a virtual AP of a plurality of virtual access points located in a physical AP device and which belongs to a multiple BSSID set. The APs 102-106 may be each located in physically separate devices and not be part of the same AP MLD, co-hosted set, virtual AP set, and/or multiple BSSID set. The STA may be an end device which wirelessly communicates with an associated AP by a wireless network protocol such as IEEE 802.11, while the AP may allow connections by nearby associated devices such as STAs to access a network such as the Internet via a wired network protocol. The STA may also be affiliated with a non-AP MLD. The wireless system 100 and components therein to perform the described functions may be implemented as one or more of analog circuitry, mix signal circuitry, memory circuitry, logic circuitry, and processing circuitry that executes code stored in a memory that when executed by the processing circuitry performs the disclosed functions.

A basic service set (BSS) defines a network topology which includes an AP and one or more STA associated with the AP. An AP and STA as described herein may be associated by an association process defined by IEEE 802.11. In one or more embodiments, AP 102 and STA 108-110 may define a BSS 114. BSS information may include capabilities and operating parameters of the BSS 114 such as one or more of a number of 20 MHz channels being the operating channel of the BSS 114 and a BSS identification (BSSID) which is a media access communication (MAC) address of the access point 102 in the BSS 114. In one or more embodiments, the AP 102 may transmit a management frame such as a beacon frame or action frame with the BSS information in an example to the associated STAs. In IEEE 802.11, the beacon frame is a management frame. The beacon frame contains information about the network or BSS. Beacon frames are transmitted periodically, by the AP and they serve to announce the presence of a BSS and to synchronize timing of the STAs in the service set with the AP.

In one or more embodiments, an AP may be in a communication range of another AP but physically separated and not in a same physical device, same MLD, same co-hosted AP set, same multiple BSSID set, or same virtual AP set. For example, an AP able to receive a frame from the other AP with an acceptable signal strength in a communication range of the other AP while if the AP is not able to receive the frame from the other AP with an acceptable signal strength then the AP is not in the communication range. The APs in the communication range are illustrated in the wireless system 100 as being proximate or a neighbor to each other. For example, AP (AP1) 102 and AP (AP2) 104 may be in a communication range while AP 106 may not in a communication range with AP 102. The AP1 may be in the BSS 114 and the AP2 and STA 112 may be in an OBSS 118 with the BSS 114 which could result in communications of one BSS interfering with communications in the OBSS. In some embodiments, the two APs in different locations may not be able to communicate with each other directly, but can communicate with each other through the STA(s) associated with one or the two APs.

In one or more embodiments, an AP such as neighbor AP2 may define a time when the AP2 and associated STA(s) with AP2 that is/are the member(s) of the TWT may exchange frames. The time is defined by a restricted target wake time (r-TWT) schedule 150 of the AP2 defined by IEEE 802.11be. With TWT operation, AP2 is recommended to do the frame exchange with its associated STA(s) that is the member of the TWT schedule at a pre-scheduled time (TWT service periods (SPs) of the TWT schedule) although the AP2 and the STAs can still do the frame exchanges outside the TWT SPs of the TWT schedule. In IEEE 802.11ax standards, two types of TWT operation are possible-individual TWT operation and broadcast TWT operation. Each individual TWT agreement can be established between two STAs or between a STA and an AP. On the other hand, with broadcast TWT operation, an AP announces the broadcast TWT schedules and sets up for a group of STA a TWT membership for the broadcast TWT schedule where the groups of the STAs negotiate for the TWT memberships with the broadcast TWT schedule successfully with the AP. In traditional TWT, access points (APs) and associated stations negotiate specific times to communicate, thereby decreasing the collision by allowing the different stations to transmitting or receiving data in different time. The r-TWT operation refines this concept by introducing more granular control and scheduling flexibility. The r-TWT schedule allows the AP2 to specify not only the times for frame exchanges but also the restrictions to the STAs that are not the members of the r-TWT schedule around these times to better guarantee the members of the r-TWT schedule can do frame exchanges. An r-TWT schedule 150 is defined by a start time 154 of a r-TWT service period (SP) 152, duration of the service period 152, and an r-TWT interval 156 which defines a time between a start of successive r-RWT service periods. The r-TWT schedule may define a plurality of service periods in an example and each AP may have one or multiple respective r-TWT schedules with each schedule having its own start time, interval, and duration. The AP2 or its associated STA that is not the member of a r-TWT schedule need to end its TXOP at the beginning of the r-TWT SP owned by the r-TWT schedule. The AP2 is arranged to be ready and available to do the frame exchanges with the STAs (r-TWT members) of a r-TWT schedule at the start time of each r-TWT SP of the r-TWT schedule and reserve the communication medium during the r-TWT SP to allow for transmitting or receiving latent sensitive frames with the STAs (r-TWT members) in the BSS to achieve more predictable latency for the frames.

Embodiments disclosed herein are directed to one or more of the APs having respective r-TWT coordination functionality 120 (e.g., implemented as processing circuitry that executes code stored to perform the disclosed functions) to facilitate respect of r-TWT schedules by each other. R-TWT coordination is a process to negotiate the r-TWT agreement between the APs and involves exchange/negotiation of the agreed r-TWT schedule(s) of one AP (AP2) with its peer AP (AP1) so that the other AP (AP1) respects the AP's (AP2's) r-TWT schedule(s) agreed by AP1. Accordingly, AP1's r-TWT schedule(s) can be negotiated/agreed by AP2 so that AP2 respects the AP1's r-TWT schedule(s) agreed by AP2. To illustrate, if an AP1 is in a BSS and AP2 is in another OBSS, then the AP1 needs to negotiate the r-TWT agreement and negotiate/acquire AP2's r-TWT schedule(s) 150 to respect the r-TWT schedule of AP2. The r-TWT schedule may be received via newly defined action frames for r-TWT agreement negotiation (r-TWT coordination request, r-TWT coordination response, r-TWT coordination confirm). As another embodiment, newly defined action frames are used for r-TWT coordination negotiation while the beacon of AP2 is used by AP1 to acquire the agreed r-TWT schedules of AP2. In one or more embodiments, an STA and AP may exchange frames during a respective transmit opportunity (TXOP) time within the r-TWT SP. The TXOP is a time duration during which the STA can send frames to the associated AP or vice versa over a reserved communication medium which in this case is an air interface. The AP1 and an associated station may transmit frames in a TXOP 158 which does not overlap with the r-TWT SP of the AP2 and/or the TXOP 158 may end at the beginning of a r-TWT service period of AP2 thereby respecting the r-TWT schedule of AP2. For example, an ultra-high reliability (UHR) STA associated with AP1 or AP1 that supports r-TWT ends its TXOP at the start time of a AP2's r-TWT SP of an r-TWT schedule agreed by AP1. An AP (AP1 as the example) needs to announces AP2's r-TWT schedule in AP1's beacon in order to let AP1's associated STA supporting the r-TWT schedule to end its TXOP at the beginning of a r-TWT service period of AP2. To indicate the r-TWT schedule of AP2 in AP1's beacon, a reserve bit in a request type of a broadcast TWT parameter set carried by a beacon of AP1 or repurposed bit in the request type may be set to indicate that the related r-TWT schedule is AP2's r-TWT schedule agreed by AP1. In another embodiment, an OBSS r-TWT index element carried in the beacon indicates a location of a broadcast TWT parameter set having AP2's r-TWT schedule(s) in a TWT element. Based on the r-TWT schedule, an AP1 may announce in a beacon the r-TWT schedule(s) of the AP2 agreed by AP1 to AP1's associated STAs to respect the r-TWT schedule(s). In some embodiments, an AP1 does not announce the agreed r-TWT schedule(s) of AP2 in a beacon to its associated STAs and an r-TWT SP of the AP2 is respected by mandating the STAs associated with AP1 to initiate its TXOP by an initial control frame (ICF), e.g., BSRP Trigger, MU-RTS, RTS, that solicits the responding control frame (e.g. Multi-STA BA, CTS). In some embodiment, AP1 transmits the responding control frame with the updated ending time of the TXOP. In some embodiment, the updated ending time of the TXOP makes sure that the TXOP ends at the beginning time of AP2's r-TWT SP if the original end time of the TXOP overlaps with the AP2's r-TWT SP.

Each of the AP1 and STA may further have a clock. The clock may be a timing synchronization function (TSF) time specified by the IEEE 802.11 wireless local area network (WLAN) standard. Further, the TSF time of an STA associated with AP1 may be synchronized with the TSF time of the associated AP1 by periodically exchanging timing information through beacon frames with the associated AP1. The TSF time of the STA may be used to determine a start time of the r-TWT SP of AP2 in an OBSS. The start time of the r-TWT SP of AP2's r-TWT schedule carried in AP1's beacon is represented by either a full TSF time [47:0] in AP1's TSF time or a partial TSF time in AP1's TSF time, e.g., TSF [25:10] in granularity of a time unit (TU). Because the AP1 and AP2 may have a clock offset because respective clocks are not synchronized and the AP2 has a clock drift of the TSF time, the clock drift and a TU start time difference (or TSF start time difference) is also provided to the STAs in a beacon as critical information that the STA needs to decode to determine when the r-TWT SP of the AP2 actually begins so that the STA is able to respect the r-TWT SP start time of the AP2.

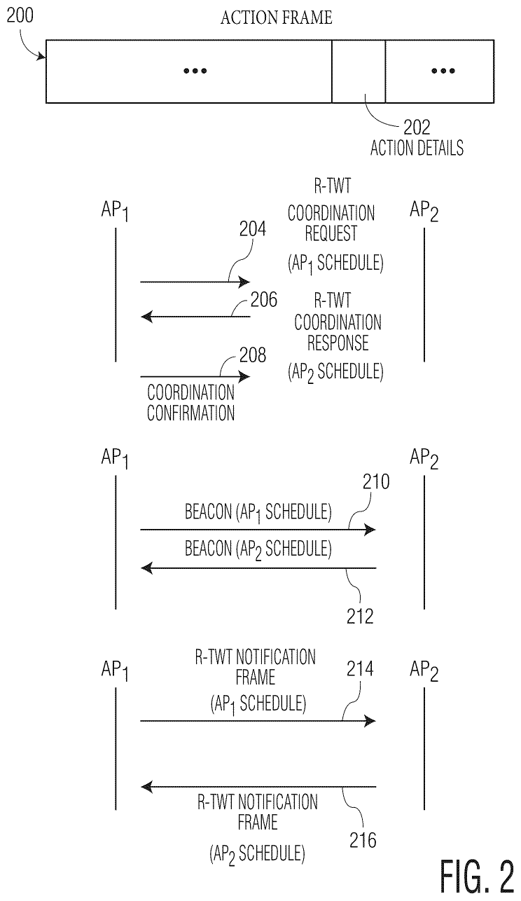

FIG. 2 illustrates various examples associated with r-TWT coordination of AP1 in a BSS and AP2 in an OBSS in accordance with one or more embodiments. The AP1 may obtain the r-TWT schedule of the AP2 along with broadcasting the r-TWT schedule of the AP2 in a beacon to the STAs associated with the AP1 so that transmission by the STA associated with AP1 in a TXOP does not overlap with a start time of an SP of the r-TWT schedule of the AP2 to respect the r-TWT schedule of the AP2.

In one more embodiments, AP1 may negotiate whether it will respect the r-TWT schedule of the AP2 and the negotiation of the r-TWT schedule being respected is done through the public action frame. Public action frames, an example of which is shown as action frame 200, are a type of management frame used for the agreement negotiation defined by IEEE 802.11. An action details field 202 of the action frame 200 indicates an action to perform and various information carried by the action frame 200. The AP1 and AP2 may transmit action frames to negotiate respect of r-TWT schedules, examples of which are frames 204-208, 214-216.

In one or more embodiments, AP1 may transmit a r-TWT Coordination Request 204 that carries a request for the AP2 to respect the r-TWT schedule of AP1 in the r-TWT Coordination Request 204. The r-TWT Coordination Request 204 may also carry the r-TWT schedule(s) of the AP1 to the AP2 that request AP2's agreement to respect the carried r-TWT schedule(s) that need to be agreed by AP2. After receiving the request, the AP2 may send an r-TWT Coordination Response 206 which carries the r-TWT schedule(s) of the AP1 and an indication whether it will respect the r-TWT schedule(s) of the AP1. Further, the r-TWT Coordination Response 206 may carry the r-TWT schedule(s) of the AP2 and a request for AP1 to respect the r-TWT schedule(s) of AP2. After receiving the response from AP2, the AP1 may further respond to this r-TWT Coordination Response 206. The AP1 may send an r-TWT Coordination Confirmation 208 which indicates whether the r-TWT schedule(s) of the AP2 will be respected. A type of the action frame and r-TWT schedule(s) may be carried in the action details 202 of the action frame 200.

In one more embodiments, the r-TWT Coordination Request transmitted by the AP1 does not carry the r-TWT schedule(s) of the AP1 and the r-TWT Coordination Response transmitted by the AP2 does not carry the r-TWT schedule(s) of AP2. The r-TWT Coordination Request and r-TWT Coordination Response are used to negotiate respect of respective r-TWT schedule(s) and AP1 acquires the r-TWT schedule(s) of AP2 and vice versa through beacons. The beacon 210 transmitted by the AP1 carries the r-TWT schedule(s) of the AP1 and similarly the beacon 212 transmitted by the AP2 carries the r-TWT schedule(s) of the AP2. Each AP will receive the other's beacon and r-TWT schedule to acquire the respective r-TWT schedule.

In one more embodiments, the r-TWT Coordination Request transmitted by the AP1 does not carry the r-TWT schedule(s) of the AP1 and the r-TWT Coordination Response transmitted by the AP2 does not carry the r-TWT schedule(s) of AP2. Instead, an AP1 notifies another AP2 of its r-TWT schedule(s) and vice versa through another public action frame such as a r-TWT Notification frame 214, 216. A type of the action frame and r-TWT schedule may be carried in the action details 202 of the action frame 200.

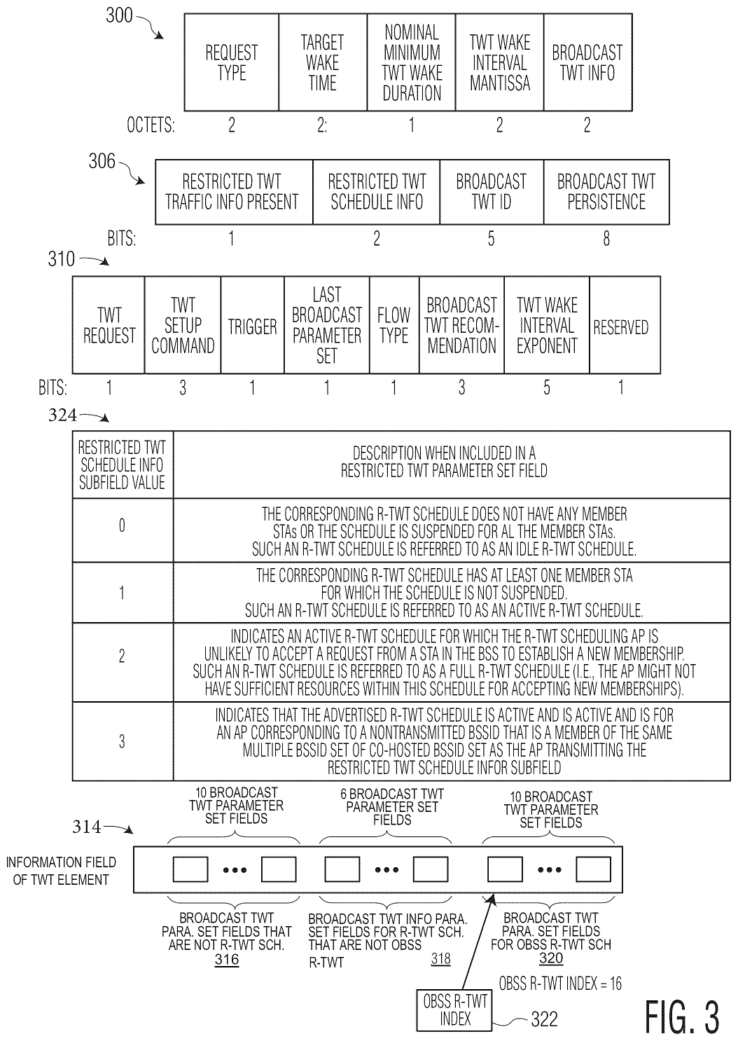

FIG. 3 illustrates example formats of fields in the beacon to indicate the r-TWT schedule of an AP in accordance with one or more embodiments. The r-TWT schedule may be indicated by an AP in a BSS to an associated STA in the BSS or neighbor AP. The r-TWT schedule may be that of an AP in an OBSS whose r-TWT schedule is to be respected by the AP in the BSS and associated STAs. The r-TWT schedule is included in the beacon so that the STA associated with the AP is able to make sure than frame transmissions in its TXOP does not overlap with a start time of the r-TWT SPs of the r-TWT schedule. In one or more embodiments, the beacon may include a broadcast TWT parameter set 300. The broadcast TWT parameter set 300 in the beacon includes a target wake time field, a TWT wake duration field, and TWT wake interval field to define an r-TWT schedule of an AP along with a broadcast TWT information field and a request type field among other fields. The broadcast TWT information field includes a subfield 306 having a restricted TWT schedule information subfield. A value of the restricted TWT schedule information subfield ranges from 0 to 3 as shown by table 324 to indicate an r-TWT schedule. A setting of 0 may indicate the r-TWT schedule has no STA members or is suspended for all STA members while a setting of 1 may indicate that the r-TWT schedule has at least one STA for which the r-TWT schedule is not suspended. A setting of 2 may indicate that an AP is not likely to accept a request from an STA for an r-TWT schedule and a setting of 3 may indicate that the r-TWT schedule is active for an AP.

The request type field of the broadcast TWT parameter set 300 has subfields 310 which includes a reserved subfield. In one or more embodiments, a reserved bit in the reserved subfield of the request type field or a bit in the request type field is repurposed to indicate whether the r-TWT schedule information in the r-TWT schedule information subfield of the broadcast TWT information field and r-TWT schedule defined in the broadcast parameter field 300 transmitted in a beacon is for a r-TWT schedule of an AP in an OBSS. The r-TWT schedule information of the AP in the OBSS is explicitly differentiated from the r-TWT schedule information of the co-host APs if exists and the r-TWT schedule of the virtual APs and which belongs to a multiple BSSID set of the AP in the BSS.

In some embodiments, the r-TWT schedule that is announced is distinguished from an r-TWT schedule of an AP in an BSS by an auxiliary element (OBSS R-TWT Index element) 322 transmitted in the beacon. A TWT element 314 transmitted in the beacon has a plurality of broadcast TWT parameter set fields 316-320 each with corresponding plurality of broadcast TWT parameter set fields. The broadcast TWT parameter set fields 316-320 include broadcast TWT parameter set fields 316 that include r-TWT schedules and broadcast TWT parameter set fields 318 that include r-TWT schedules that are not OBSS r-TWT schedules, and broadcast TWT parameter set fields 320 that include r-TWT schedules that are OBSS r-TWT schedules. The auxiliary element 322 (OBSS R-TWT Index element) may have the index value(s) such as 16 to identify the location where the broadcast TWT parameter set field 320 of r-TWT schedule of APs in a OBSS starts in the TWT element 314 which is followed by the broadcast TWT parameter set fields for OBSS r-TWT schedule information. In the example TWT element 314, the broadcast TWT parameter set fields for to the OBSS AP is the 16^{th} broadcast TWT parameter set field carried by the TWT element corresponding to the index value that is illustrated.

The TSF time of the APs have a clock offset and a respective clock drift. Because of this clock offset and clock drift, a determination by the AP (AP1) in a BSS based on AP1's TSF time of when an r-TWT SP of the AP in a OBSS (AP2) starts may differ from when AP2 actually starts the r-TWT SP based on AP2's TSF time. The start time of an r-TWT SP of AP2 in the r-TWT schedule is also in a granularity of TU but the r-TWT SP's start time of AP2 based on AP1's TSF may not be in terms of a TU granularity because the clocks of AP1 and AP2 are not synchronized as identified by the clock offset and clock drift.

In one more embodiments, a new element is defined and transmitted in the beacon to the STA to indicate the clock drift of a TSF in AP2 and a TU start time difference (or TSF start time difference) based on AP1's TSF time and AP2's TSF time. An ultra-high reliability (UHR) STA that supports r-TWT operation cannot have its TXOP to overlap with the start time of its AP2's r-TWT SP in an OBSS. The STA receives the beacon and uses the clock drift and the TU start time difference to determine when the r-TWT SP of the AP2 actually starts. The TSF time of the STA may reach a TU time indicating a start time of the r-TWT SP using AP1's TSF time but because the TSF time of the STA associated with AP1 is not synchronized with the TSF time of the AP2, the same TU start time of the AP2 may not be reached or is already reached. The STA adjusts the TU start time by the TU start time difference (which could have a granularity less than a TU) so that the start time of the r-RWT SP determined by the AP1 matches the exact start time of the r-TWT SP by the AP2. Further, the STA adjust the start time for the clock drift of the TSF of the AP2. Based on the r-TWT SP start time and duration, the STA stops any TXOP frame transmission that overlaps with a start time of the r-TWT SP of the AP2.

In one more embodiments, the AP in a BSS may respect an r-TWT schedule of an AP in an OBSS without broadcast of the r-TWT schedule of the AP in the OBSS in a beacon which is received by STA associated with the AP in the BSS.

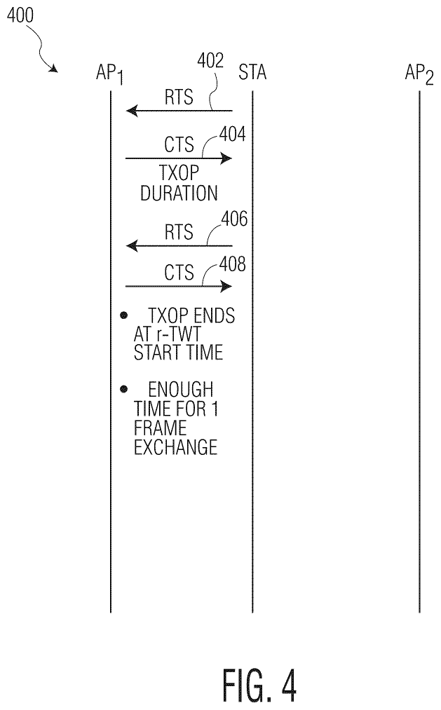

FIG. 4 illustrate example communications 400 by AP1 and associated STA to respect a r-TWT schedule of AP2 in an OBSS where the r-TWT schedule of AP2 is not announced by AP1 to associated stations in accordance with one or more embodiments. Various examples of communication between the AP1 and STA are illustrated that allows for respect of the r-TWT schedule of AP2 received by methods of FIG. 2 without the AP1 having to announce the r-TWT schedule of the AP2 to an associated STA in a beacon or action frame. To respect the r-TWT schedule of the AP2, AP1 mandates use of initial control frame by the STA (e.g., buffer status report (BSRP) Trigger to check how much buffered data is ready to send, MU RTS, or request to send (RTS)) and responding control frame by the AP (e.g., multi-STA block acknowledgement (BA) or clear to send (CTS)) between the AP and STA before any communication between the AP and associated STA. The RTS and CTS as the example may be control frames in an example that are transmitted between each other. The RTS sent by an STA may be a request by the STA to transmit a frame in a TXOP and the CTS sent by the AP may be an acknowledgement for the STA to send the frame in the TXOP or an adjusted TXOP.

In one more embodiments, an STA may send an RTS 402 to the AP1 to transmit in a TXOP having a duration. When the AP1 receives the RTS 402 from the STA whose TXOP duration covers the start time of an OBSS r-TWT SP, the AP1 transmits a CTS 404 whose duration indicates the earlier end of the TXOP so that the frame exchanges of the TXOP will end at the start time of an OBSS r-TWT SP.

In one more embodiments, when the AP1 receives a RTS 406 from a STA whose duration covers the start time of an OBSS r-TWT SP, the AP1 will respond by transmitting the CTS 408 if the CTS transmission will end before the start time of an OBSS r-TWT SP. Otherwise, the CTS 408 may not be transmitted.

In one more embodiments, when the AP1 receives a RTS 406 from a STA whose duration covers the start time of an OBSS r-TWT SP, the AP1 will respond by transmitting the CTS 408 only if a duration does not cover the start time of the r-TWT SP. Otherwise, the AP1 will not send the CTS 408.

In one more embodiments, when the AP1 receives a RTS 406 from an STA whose duration covers the start time of the r-TWT SP of AP2, the AP1 will respond with the CTS 408 if remaining time before start of the r-TWT SP is enough for one frame exchange, e.g., a physical layer protocol data unit (PPDU) transmission and acknowledgement, between the AP and STA. Otherwise, if the remaining time is not enough for one frame exchange then the AP1 will not send the CTS 408.

R-TWT respect may be accomplished by an AP1 offering a protected service period for its member STAs of an associated AP1 in a BSS by sending via a beacon or action frame quiet elements defined by IEEE 802.11 to other STAs in the BSS, where a quiet interval corresponding to the quiet element overlaps with at least an initial portion of the r-TWT SP of the AP2 in an OBSS. During the quiet interval the AP1 and associated STA do not transmit frames in an TXOP. In one or more embodiments, AP1 may schedule at most one quiet interval with the STA that overlaps with an r-TWT SP of AP2, with or without announcing the r-TWT schedule of the AP2, where each of the two APs agrees to respect the r-TWT schedules of each other. AP1 does not need to announce the r-TWT schedule of the AP2 to the STA in a beacon or action frame.

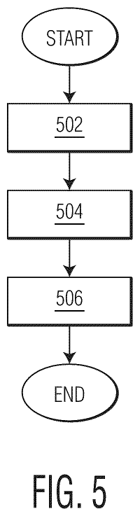

FIG. 5 is an example flow chart 500 of functions associated with r-TWT coordination between an AP in a BSS and AP in an OBSS in accordance with one or more embodiments. The AP in the BSS and AP in the OBSS may be wireless devices. At 502, an AP in the BSS acquires an r-TWT schedule of the AP in the OBSS which is respected by the AP in the BSS. The AP in the BSS may acquire this schedule based on an action frame exchange or receiving a beacon which indicates the r-TWT schedule of the AP in the OBSS. The AP in the BSS may indicate the respect also based on the action frame exchange or a separate action frame. At 504, the AP in the BSS provides an indication of the r-TWT schedule of the AP in the OBSS to associated STA of the AP in the BSS. The indication may be in the form of a beacon where a field in the beacon may indicate that the r-TWT schedule is associated with the AP in the OBSS rather than the r-TWT schedule of the AP in the BSS. Further, the beacon may indicate a clock drift of a TSF time of the AP in the OBSS and a time unit (TU) start time difference (or TSF start time difference) of the r-TWT service period (SP) of the AP in the OBSS determined based on respective TSF of the AP in the BSS and AP in the OBSS which are used by the STA to determine an actual start time of a r-TWT SP of the AP in the OBSS. Alternatively, the APs and associated STA may respect the r-TWT schedule of the AP in the OBSS based on an RTS/CTS exchange. At 506, the STA may transmit in a TXOP which ends at start time of a r-TWT SP of the AP in the OBSS to respect the r-TWT schedule of the AP in the OBSS.

In one or more embodiments, AP1 is referred to as being in a BSS and AP2 is referred to as being in an OBSS. In other embodiment, the AP2 may be in a BSS and AP1 may be in an OBSS. AP2 may perform the operations described for AP1 and AP1 may perform the operations described for AP2 without limitation in that AP2 also respects the r-TWT schedule of AP1.

In one or more embodiments, a restricted target wake time (r-TWT) coordination method for a first AP to respect an r-TWT schedule of a second AP is disclosed where the second AP is in an overlapping basic service set (OBSS). The method includes acquiring, by the first AP, the r-TWT schedule of the second AP; indicating, by the first AP to the second AP, that the first AP respects the r-TWT schedule of the second AP; and providing, by the first AP, to a station associated with the first AP an indication of the r-TWT schedule of the second AP to cause a frame exchange with the STA of the first AP to end at a beginning of a r-TWT service period of the second AP to respect the r-TWT schedule of the second AP. In one or more embodiments, acquiring the r-TWT schedule of the second AP comprises receiving a public action frame from the second AP having the r-TWT schedule of the second AP wherein the public action frame is for r-TWT coordination negotiation. In one or more embodiment, indicating that the first AP respects the r-TWT schedule of the second AP comprises transmitting, by the first AP, a r-TWT coordination response in response to a r-TWT coordination request transmitted by the second AP that carries the r-TWT schedule of the second AP, the request and response being public action frames. In one or more embodiments, the method further includes transmitting, by the first AP, a r-TWT coordination confirmation in response to the r-TWT coordination response transmitted by the second AP that carries the second r-TWT schedule of the second AP, the coordination confirmation being a public action frame. In one or more embodiments, acquiring the r-TWT schedule includes receiving the r-TWT schedule in a r-TWT notification frame which is a public action frame, and wherein indicating that the first AP respects the r-TWT schedule of the second AP includes transmitting, by the first AP, a r-TWT coordination response in response to a r-TWT coordination request transmitted by the second AP which does not carry the r-TWT schedule. In one or more embodiments, acquiring the r-TWT schedule includes receiving a beacon from the second AP having the r-TWT schedule. In one or more embodiment, providing to the station the r-TWT schedule includes transmitting a beacon to the station with a repurposed bit in a request type field of a broadcast TWT parameter set which indicates that the r-TWT schedule in the broadcast TWT parameter set is for the second AP. In one or more embodiments, the beacon further indicates a timing synchronization function (TSF) clock drift of the second AP and time unit (TU) starting difference of a TSF time of the second AP with respect to a TSF time of the first AP. In one or more embodiments, providing to the station the r-TWT schedule includes transmitting a beacon to the station with an OBSS r-TWT index element which indicates a location of the r-TWT schedule of the second AP in an target wake time (TWT) element having a plurality of broadcast TWT parameter sets. In one or more embodiments, providing to the station the r-TWT schedule includes receiving a request to send (RTS) from the station associated with the first AP and sending in response to the RTS a clear to send (CTS) with a duration of a TXOP that ends when the r-TWT service period (SP) of the second AP begins. In one or more embodiments, providing to the station the r-TWT schedule includes receiving a request to send (RTS) from the station associated with the first AP and sending in response to the RTS an clear to send (CTS) if one or more of a transmit opportunity (TXOP) ends when the r-TWT service period (SP) of the second AP begins and one frame exchange is able to be completed before the r-TWT SP of the second AP starts.

In one or more embodiments, access point (AP) in a basic service set (BSS) is arranged to perform a restricted target wake time (r-TWT) coordination to respect an r-TWT schedule of an AP in an overlapping BSS (OBSS). The AP in the BSS includes circuitry configured to acquire the r-TWT schedule of the AP in the OBSS; indicate to the AP in the OBSS that the AP respects the r-TWT schedule of the AP in the OBSS; and provide to a station associated with the AP in the BSS an indication of the r-TWT schedule of the AP in the OBSS to cause a frame exchange with the STA of the AP in the BSS to end at a beginning of a r-TWT service period of the AP in the OBSS to respect the r-TWT schedule of the AP in the OBSS. In one or more embodiments, the circuitry configured to acquire the r-TWT schedule includes circuitry configured to receive a public action frame from the AP in the OBSS having the r-TWT schedule of the AP in the OBSS, wherein the public action frame is for r-TWT coordination negotiation. In one or more embodiments, the indication that the AP in the BSS respects the r-TWT schedule of the AP in the OBSS is provided in a r-TWT coordination response transmitted by the AP in the BSS in response to a r-TWT coordination request transmitted by the AP in the BSS, the request and response being public action frames. In one or more embodiments, the r-TWT schedule of the AP in the OBSS is acquired by a r-TWT notification frame which is a public action frame and wherein the indication that the AP in the BSS respects the r-TWT schedule of the AP in the OBSS is a r-TWT coordination response transmitted by the AP in the BSS in response to a r-TWT coordination request transmitted by the AP in the OBSS which does not carry the r-TWT schedule. In one or more embodiments, the r-TWT schedule is acquired in a beacon received from the AP in the OBSS and having the r-TWT schedule. In one or more embodiments, the r-TWT schedule is provided to the station by transmitting a beacon to the station with a repurposed bit in a request type field of a broadcast TWT parameter set which indicates that the r-TWT schedule in the broadcast TWT parameter set is for the AP in the OBSS. In one or more embodiments, the beacon further indicates a timing synchronization function (TSF) drift of the AP in the OBSS and time unit (TU) starting difference of a TSF time of the second AP with respect to a TSF time of the first AP. In one or more embodiments, the r-TWT schedule is provided to the station by transmitting a beacon having an OBSS r-TWT index element which indicates a location of the r-TWT schedule of the AP in the OBSS within an target wake time (TWT) element having a plurality of broadcast TWT parameter sets. In one or more embodiments, the circuitry arranged to provide to the station the r-TWT schedule includes circuitry to receive a request to send (RTS) from the station associated with AP in the BSS and send a clear to send (CTS) with a duration of a transmit opportunity (TXOP) that ends when the r-TWT service period of the AP in the OBSS starts. In one or more embodiments, the circuitry arranged to provide to the station the r-TWT schedule includes circuitry to receive a request to send (RTS) from the station associated AP in the BSS and send a clear to send (CTS) when one or more of a TXOP ends when the r-TWT service period of the AP in the OBSS starts and one frame exchange is able to be completed before the r-TWT SP of the second AP starts. In one or more embodiments, the AP arranged to indicate that the first AP respects the r-TWT schedule of the second AP includes the AP arranged to transmit a r-TWT coordination confirmation in response to a r-TWT coordination response transmitted by the second AP that carries second AP's r-TWT schedules, the response and confirmation being public action frames.

A few implementations have been described in detail above, and various modifications are possible. The disclosed subject matter, including the functional operations described in this specification, can be implemented in electronic circuit, computer hardware, firmware, software, or in combinations of them, such as the structural means disclosed in this specification and structural equivalents thereof: including potentially a program operable to cause one or more data processing apparatus such as a processor to perform the operations described (such as a program encoded in a non-transitory computer-readable medium, which can be a memory device, a storage device, a machine-readable storage substrate, or other physical, machine readable medium, or a combination of one or more of them).

While this specification contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

Other implementations fall within the scope of the following claims.

We claim:

1. A restricted target wake time (r-TWT) coordination method for a first AP to respect an r-TWT schedule of a second AP, the second AP being in an overlapping basic service set (OBSS), the method comprising:
acquiring, by the first AP, the r-TWT schedule of the second AP;
indicating, by the first AP to the second AP, that the first AP respects the r-TWT schedule of the second AP; and
providing, by the first AP, to a station associated with the first AP an indication of the r-TWT schedule of the second AP to cause a frame exchange with the STA of the first AP to end at a beginning of a r-TWT service period of the second AP to respect the r-TWT schedule of the second AP.

2. The method of claim 1, wherein acquiring the r-TWT schedule of the second AP comprises receiving a public action frame from the second AP having the r-TWT schedule of the second AP wherein the public action frame is for r-TWT coordination negotiation.

3. The method of claim 2, wherein indicating that the first AP respects the r-TWT schedule of the second AP comprises transmitting, by the first AP, a r-TWT coordination response in response to a r-TWT coordination request transmitted by the second AP that carries the r-TWT schedule of the second AP, the request and response being public action frames.

4. The method of claim 3, further comprising transmitting, by the first AP, a r-TWT coordination confirmation in response to the r-TWT coordination response transmitted by the second AP that carries the second r-TWT schedule of the second AP, the coordination confirmation being a public action frame.

5. The method of claim 1, wherein acquiring the r-TWT schedule comprises receiving the r-TWT schedule in a r-TWT notification frame which is a public action frame, and wherein indicating that the first AP respects the r-TWT schedule of the second AP comprises transmitting, by the first AP, a r-TWT coordination response in response to a r-TWT coordination request transmitted by the second AP which does not carry the r-TWT schedule.

6. The method of claim 1, wherein acquiring the r-TWT schedule comprises receiving a beacon from the second AP having the r-TWT schedule.

7. The method of claim 1, wherein providing to the station the r-TWT schedule comprises transmitting a beacon to the station with a repurposed bit in a request type field of a broadcast TWT parameter set which indicates that the r-TWT schedule in the broadcast TWT parameter set is for the second AP.

8. The method of claim 7, wherein the beacon further indicates a timing synchronization function (TSF) clock drift of the second AP and time unit (TU) starting difference of a TSF time of the second AP with respect to a TSF time of the first AP.

9. The method of claim 1, wherein providing to the station the r-TWT schedule comprises transmitting a beacon to the station with an OBSS r-TWT index element which indicates a location of the r-TWT schedule of the second AP in an target wake time (TWT) element having a plurality of broadcast TWT parameter sets.

10. The method of claim 1, wherein providing to the station the r-TWT schedule comprises receiving a request to send (RTS) from the station associated with the first AP and sending in response to the RTS a clear to send (CTS) with a duration of a TXOP that ends when the r-TWT service period (SP) of the second AP begins.

11. The method of claim 1, wherein providing to the station the r-TWT schedule comprises receiving a request to send (RTS) from the station associated with the first AP and sending in response to the RTS an clear to send (CTS) if one or more of a transmit opportunity (TXOP) ends when the r-TWT service period (SP) of the second AP begins and one frame exchange is able to be completed before the r-TWT SP of the second AP starts.

12. An access point (AP) in a basic service set (BSS) arranged to perform a restricted target wake time (r-TWT) coordination to respect an r-TWT schedule of an AP in an overlapping BSS (OBSS), the AP in the BSS comprising circuitry configured to acquire the r-TWT schedule of the AP in the OBSS; indicate to the AP in the OBSS that the AP respects the r-TWT schedule of the AP in the OBSS; and provide to a station associated with the AP in the BSS an indication of the r-TWT schedule of the AP in the OBSS to cause a frame exchange with the STA of the AP in the BSS to end at a beginning of a r-TWT service period of the AP in the OBSS to respect the r-TWT schedule of the AP in the OBSS.

13. The AP of claim 12, wherein the circuitry configured to acquire the r-TWT schedule comprises circuitry configured to receive a public action frame from the AP in the OBSS having the r-TWT schedule of the AP in the OBSS, wherein the public action frame is for r-TWT coordination negotiation.

14. The AP of claim 12, wherein the indication that the AP in the BSS respects the r-TWT schedule of the AP in the OBSS is provided in a r-TWT coordination response transmitted by the AP in the BSS in response to a r-TWT coordination request transmitted by the AP in the BSS, the request and response being public action frames.

15. The AP of claim 12, wherein the r-TWT schedule of the AP in the OBSS is acquired by a r-TWT notification frame which is a public action frame and wherein the indication that the AP in the BSS respects the r-TWT schedule of the AP in the OBSS is a r-TWT coordination response transmitted by the AP in the BSS in response to a r-TWT coordination request transmitted by the AP in the OBSS which does not carry the r-TWT schedule.

16. The AP of claim 12, wherein the r-TWT schedule is acquired in a beacon received from the AP in the OBSS and having the r-TWT schedule.

17. The AP of claim 12, wherein the r-TWT schedule is provided to the station by transmitting a beacon to the station with a repurposed bit in a request type field of a broadcast TWT parameter set which indicates that the r-TWT schedule in the broadcast TWT parameter set is for the AP in the OBSS.

18. The AP of claim 17, wherein the beacon further indicates a timing synchronization function (TSF) drift of the AP in the OBSS and time unit (TU) starting difference of a TSF time of the second AP with respect to a TSF time of the first AP.

19. The AP of claim 12, wherein the r-TWT schedule is provided to the station by transmitting a beacon having an OBSS r-TWT index element which indicates a location of the r-TWT schedule of the AP in the OBSS within an target wake time (TWT) element having a plurality of broadcast TWT parameter sets.

20. The AP of claim 12, wherein the circuitry arranged to provide to the station the r-TWT schedule comprises circuitry to receive a request to send (RTS) from the station associated with AP in the BSS and send a clear to send (CTS) with a duration of a transmit opportunity (TXOP) that ends when the r-TWT service period of the AP in the OBSS starts.

21. The AP of claim 12, wherein the circuitry arranged to provide to the station the r-TWT schedule comprises circuitry to receive a request to send (RTS) from the station associated AP in the BSS and send a clear to send (CTS) when one or more of a TXOP ends when the r-TWT service period of the AP in the OBSS starts and one frame exchange is able to be completed before the r-TWT SP of the second AP starts.

22. The AP of claim 12, wherein the AP arranged to indicate that the first AP respects the r-TWT schedule of the second AP comprises the AP arranged to transmit a r-TWT coordination confirmation in response to a r-TWT coordination response transmitted by the second AP that carries second AP's r-TWT schedules, the response and confirmation being public action frames.
